(19) United States
(12) Patent Application Publication
(10) Pub. No.: US 2024/0226617 A1
(43) Pub. Date: Jul. 11, 2024

(54) COMBINATION LEG PAD AND TRAUMA STRAP

(71) Applicant: CHECKMATE LIFTING & SAFETY LTD, Kent (GB)

(72) Inventors: Judd J. Perner, Missouri City, TX (US); Andres Rubalcava, Spring, TX (US); Luis D. Herrera, Houston, TX (US)

(73) Assignee: CHECKMATE LIFTING & SAFETY LTD, Kent (GB)

(21) Appl. No.: 18/233,646

(22) Filed: Aug. 14, 2023

Related U.S. Application Data
(60) Provisional application No. 63/438,367, filed on Jan. 11, 2023.

(51) Int. Cl. A62B 35/00

(52) U.S. Cl. CPC A62B 35/0025

(57) ABSTRACT

A combination leg pad and trauma strap comprises a trauma strap and a leg pad. The trauma strap includes an intermediate portion interconnecting a proximal end and a distal end. The proximal end includes a loop forming a first portion and a second portion. The leg pad includes a pad, a pad cover, and a housing panel. The first portion is positioned proximate the housing panel and the second portion is positioned between the pad cover and the pad. The pad cover and the housing panel form a channel through the loop between the first and second portions configured and arranged to receive a leg strap of a safety harness thereby connecting the trauma strap to the safety harness when installed on the safety harness.

### BACKGROUND

Fall protection equipment is commonly used to reduce a likelihood of a fall and/or serious injuries associated with a fall, particularly by users who perform tasks at heights or are at risk of falling. Generally, lifelines or lanyards typically interconnect anchorage structures and safety harnesses donned by users. The lifelines or lanyards allow the users to move and perform tasks while being connected to the anchorage structures. Should a user fall, the fall protection equipment generally limits the distance the user falls.

Should a user fall and remain suspended by the safety harness, the user is at risk of incurring suspension trauma/orthostatic intolerance caused by restricted blood circulation that can be fatal. The leg straps support the user's weight and can constrict the user's femoral arteries. To reduce the risk of suspension trauma/orthostatic intolerance, trauma straps can be used. Typically, trauma straps are connected to the safety harness and are deployed after a fall to provide support for the user's legs and help prevent restricted blood circulation in the user's legs. Retrofitted trauma straps can add unwanted bulk to the safety harness.

For the reasons stated above and for other reasons stated below, which will become apparent to those skilled in the art upon reading and understanding the present specification, there is a need in the art for improved trauma straps.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, a combination leg pad and trauma strap comprises a trauma strap and a leg pad. The trauma strap includes an intermediate portion interconnecting a proximal end and a distal end. The proximal end includes a loop forming a first portion and a second portion. The leg pad includes a pad, a pad cover, and a housing panel. The first portion is positioned proximate the housing panel and the second portion is positioned between the pad cover and the pad. The pad cover and the housing panel form a channel through the loop between the first and second portions configured and arranged to receive a leg strap of a safety harness thereby connecting the trauma strap to the safety harness when installed on the safety harness.

In one embodiment, a combination safety harness and trauma strap comprises a trauma strap, a safety harness, and a leg pad. The trauma strap includes an intermediate portion interconnecting a proximal end and a distal end. The proximal end includes a loop forming a first portion and a second portion. The safety harness includes a leg strap. The leg pad is operatively connected to the trauma strap, and the leg pad includes a pad, a pad cover, and a housing panel. The first portion is positioned proximate the housing panel and the second portion is positioned between the pad cover and the pad. The pad cover and the housing panel form a channel through the loop between the first and second portions, and the leg strap is routed through the channel thereby connecting the trauma strap to the safety harness.

In one embodiment, a method of connecting a combination leg pad and trauma strap to a safety harness comprises obtaining a combination leg pad and trauma strap and obtaining a safety harness. The combination leg pad and trauma strap includes a leg pad and a trauma strap. The leg pad includes a pad, a pad cover, and a housing panel. The trauma strap includes an intermediate portion interconnecting a proximal end and a distal end, and the proximal end includes a loop forming a first portion and a second portion. The first portion is positioned proximate the housing panel and the second portion is positioned between the pad cover and the pad, and the pad cover and the housing panel form a channel through the loop between the first and second portions. The safety harness includes a leg strap, which is inserted through the channel, thereby positioning the leg strap between the first and second portions of the trauma strap.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a front view of embodiment left and right combination leg pads and trauma straps constructed in accordance with the principles of the present invention;

FIG. 2 is a rear view of the combination leg pads and trauma straps shown in FIG. 1;

FIG. 3 is a side view of a safety harness to which a right combination leg pad and trauma strap, constructed in accordance with the principles of the present invention, is connected;

FIG. 4 is a front view of another embodiment left and right combination leg pads and trauma straps constructed in accordance with the principles of the present invention;

FIG. 5 is a front view of the combination leg pads and trauma straps shown in FIG. 4 with a trauma strap housing in an open position;

FIG. 6 is a front view of the combination leg pads and trauma straps shown in FIG. 4 with the trauma strap housing in an open position and trauma straps deployed therefrom; and

FIG. 7 is a cross section view of a left combination leg pad and trauma strap taken along the lines 7-7 in FIG. 6.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a trauma strap that is integrated into the safety harness leg padding. Generally, this moves the location of a traditional trauma strap from proximate the hip area down to the outer thigh area. This not only conceals and fixes the trauma strap to the user's body, but it eliminates the need to connect another article of equipment to the user thereby reducing bulk. It also reduces the risk of losing or removing the trauma strap from the harness by mistake and the risk of connecting the trauma strap incorrectly to the safety harness. In one embodiment, the trauma strap is integrated into the leg padding connected during manufacture of the safety harness and cannot be removed by users. In another embodiment, the combination leg pad and trauma strap can be connected to the leg strap of a fully assembled safety harness.

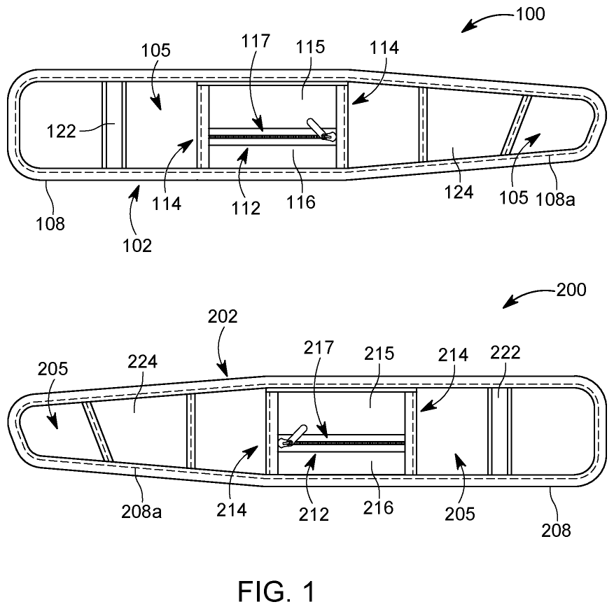

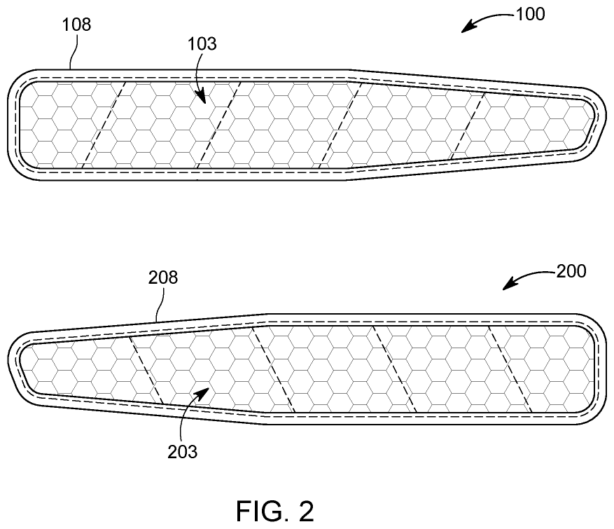

In one embodiment, illustrated in FIGS. 1-2, a left combination leg pad and trauma strap 100 and a right combination leg pad and trauma strap 200 are preferably generally mirror images of each other but could have differing configurations. The left combination leg pad and trauma strap 100 includes a base 102, which preferably comprises mesh 103, padding (not shown), and a pad cover 105 connected with piping 108 and stitching 108a. A trauma strap housing 112 is operatively connected to the base 102, preferably also with the piping 108 and stitching 108a. The housing 112 includes a housing panel (not shown) to which a top panel 115 and a bottom panel 116 are operatively connected, and a fastener 117 releasably connects the top and bottom panels 115 and 116 to allow access to a cavity (not shown) between the housing panel and the top and bottom panels 115 and 116. Although the fastener 117 is shown as a zipper, it is recognized that other suitable fasteners could be used such as hook and loop, snaps, magnets, etc. The cavity is configured and arranged to receive at least a portion of a trauma strap (not shown). The pad cover 105 and the housing panel form a channel 114 therebetween and extending between the piping 108 on the top and bottom. Optionally, a securing strap 122 and a securing sleeve 124 are operatively connected, preferably via the piping 108 and stitching 108a, to the base 102 on opposing sides of the housing 112. The channel 114 and channels formed by the securing strap 122 and securing sleeve 124 are configured and arranged to receive a leg strap of a safety harness thereby connecting the left combination leg pad and trauma strap 100 to the safety harness. An example of how the trauma strap can be connected is described in another embodiment.

Similarly, the right combination leg pad and trauma strap 200 includes a base 202, which preferably comprises mesh 203, padding (not shown), and a pad cover 205 connected with piping 208 and stitching 208a. A trauma strap housing 212 is operatively connected to the base 202, preferably also with the piping 208 and stitching 208a. The housing 212 includes a housing panel (not shown) to which a top panel 215 and a bottom panel 216 are operatively connected, and a fastener 217 releasably connects the top and bottom panels 215 and 216 to allow access to a cavity (not shown) between the housing panel and the top and bottom panels 215 and 216. Although the fastener 217 is shown as a zipper, it is recognized that other suitable fasteners could be used such as hook and loop, snaps, magnets, etc. The cavity is configured and arranged to receive at least a portion of a trauma strap (not shown). The pad cover 205 and the housing panel form a channel 214 therebetween and extending between the piping 208 on the top and bottom. Optionally, a securing strap 222 and a securing sleeve 224 are operatively connected, preferably via the piping 208 and stitching 208a, to the base 202 on opposing sides of the housing 212. The channel 214 and channels formed by the securing strap 222 and securing sleeve 224 are configured and arranged to receive a leg strap of a safety harness thereby connecting the right combination leg pad and trauma strap 200 to the safety harness. An example of how the trauma strap can be connected is described in another embodiment.

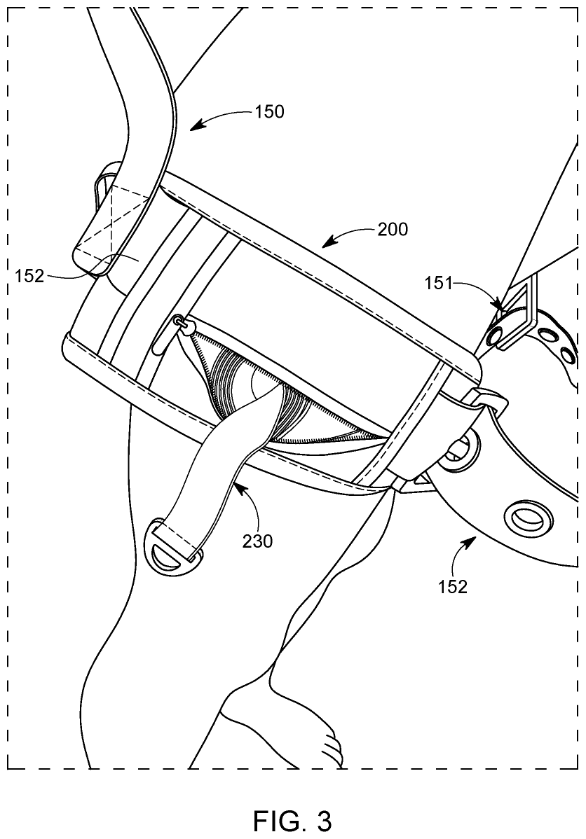

FIG. 3 shows a safety harness 150 including a left leg strap 151 and a right leg strap 152 to which combination leg pad and trauma straps can be connected. Any suitable safety harness can be used. A right combination leg pad and trauma strap 200, including a trauma strap 230, is shown connected to the right leg strap 152. This is described in more detail below.

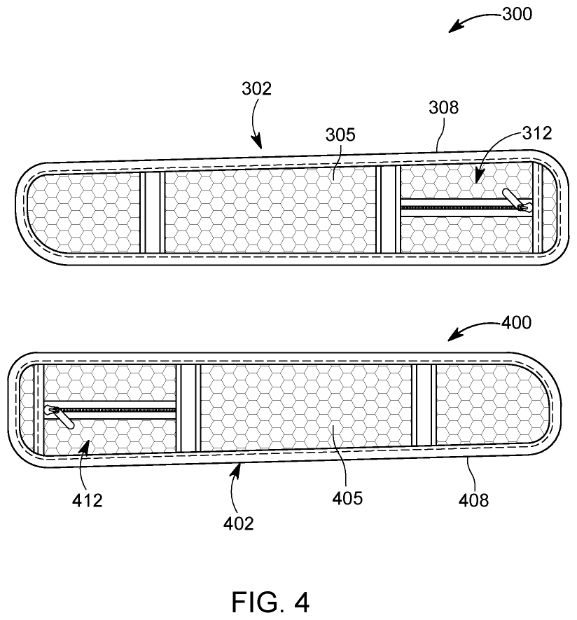

In one embodiment, illustrated in FIGS. 4-7, a left combination leg pad and trauma strap 300 and a right combination leg pad and trauma strap 400 are preferably generally mirror images of each other but could have differing configurations. The left combination leg pad and trauma strap 300 includes a base 302, which preferably comprises mesh 303, padding 304, and a pad cover 305 connected with piping 308 and stitching. A trauma strap housing 312 is operatively connected to the base 302, preferably also with the piping 308 and stitching. The housing 312 includes a housing panel 313 to which a top panel 315 and a bottom panel 316 are operatively connected, and a fastener 317 releasably connects the top and bottom panels 315 and 316 to allow access to a cavity 318 between the housing panel 313 and the top and bottom panels 315 and 316. Although the fastener 317 is a zipper in this embodiment, other suitable fasteners could be used. The cavity 318 is configured and arranged to receive at least a portion of a trauma strap 330. The pad cover 305 and the housing panel 313 form a channel 314 therebetween that extends between the piping 308 on the top and the bottom. Optionally, a securing strap 322 is operatively connected, preferably via the piping 308 and stitching, on opposing sides of the housing 312 (top and bottom), to the base 302. The channel 314 and a channel formed by the securing strap 322 are configured and arranged to receive a leg strap of a safety harness thereby connecting the left combination leg pad and trauma strap 300 to the safety harness.

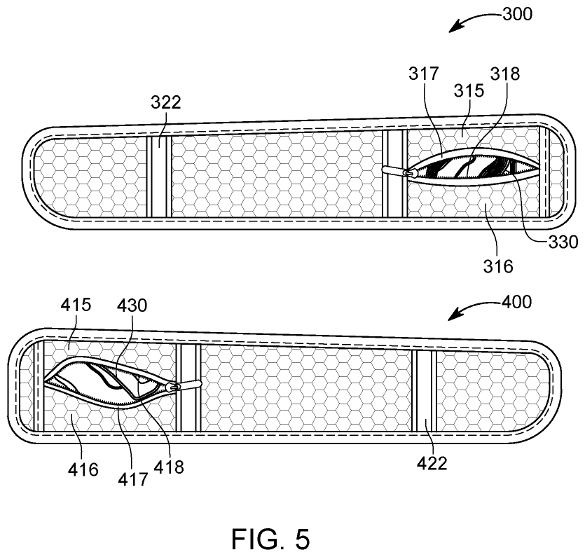

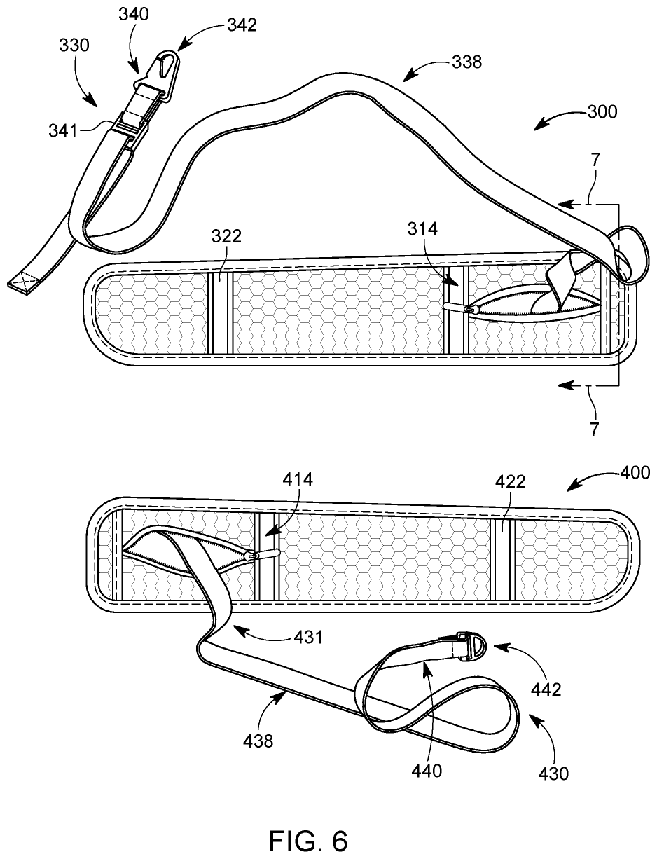

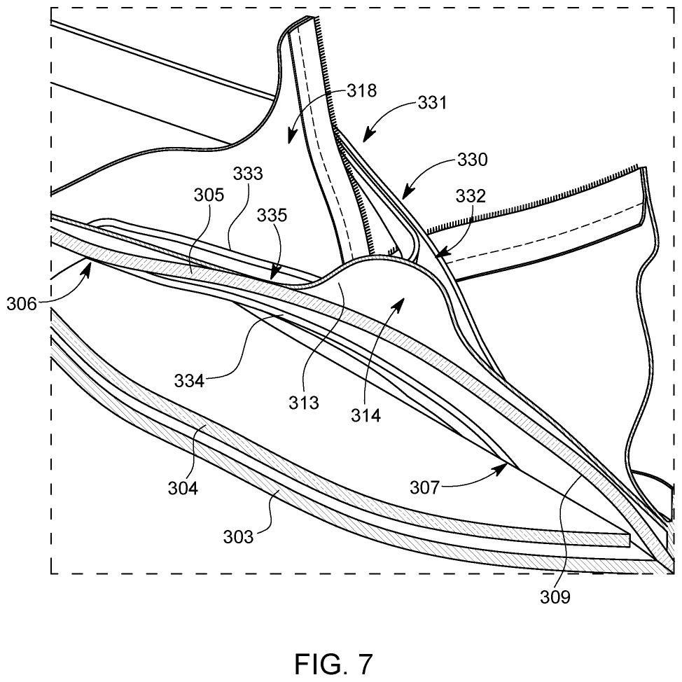

An example of how the trauma strap 330 can be connected is shown in FIG. 7. An example trauma strap 330 includes an intermediate portion 338 interconnecting a proximal end 331 and a distal end 340. A loop 332 is formed in the proximal end 331 and defines an opening 335. The distal end 340 includes an optional adjuster 341, to adjust the length of the trauma strap 330, and a connector 342, which could be a hook, ring, loop, portion of a hook and loop fastener, portion of a snap, etc. Preferably, there are a first opening 306 and a second opening 307, proximate a bottom and a top of the trauma strap housing 312, through the housing panel 313 and the pad cover 305, through which portions of the loop 332 of the trauma strap 330 extend so that a first portion 333 of the trauma strap 330 is positioned proximate the housing panel 313 within the cavity 318 of the trauma strap housing 312 and a second portion 334 of the trauma strap 330 is positioned within a channel 309 between the pad cover 305 and the padding 304. The pad cover 305 and the housing panel 313 form the channel 314, which extends through the opening 335 of the loop 332 between the first and second portions 333 and 334, and which is configured and arranged to receive a leg strap of a safety harness thereby connecting the trauma strap 330 to the safety harness when installed on the safety harness. In other words, when the leg strap is routed through the channel 314, the leg strap is also routed through the loop 332 thereby connecting the trauma strap to the safety harness. Optionally, the trauma strap housing and/or the trauma strap can be secured to the leg strap of the safety harness, for example with stitching. The trauma strap 330 is folded or rolled into a storage position (FIG. 5) when contained in the trauma strap housing 312 and is unfolded or unrolled and deployed into a use position (FIG. 6) when the intermediate portion 338 and distal end 340 are taken out of the trauma strap housing 312. In the use position, the connector 342 is used to form a loop, either with the same trauma strap (for one foot) or a trauma strap on the other side of the user (for both feet), to support the user's foot or feet, which relieves some of the pressure exerted on the user's legs to reduce the risk of suspension trauma/orthostatic intolerance.

Similarly, the right combination leg pad and trauma strap 400 includes a base 402, which preferably comprises mesh, padding, and a pad cover 405 connected with piping 408 and stitching. A trauma strap housing 412 is operatively connected to the base 402, preferably also with the piping 408 and stitching. The housing 412 includes a housing panel to which a top panel 415 and a bottom panel 416 are operatively connected, and a fastener 417 releasably connects the top and bottom panels 415 and 416 to allow access to a cavity 418 between the housing panel and the top and bottom panels 415 and 416. Although the fastener 417 is a zipper in this embodiment, other suitable fasteners could be used. The cavity 418 is configured and arranged to receive at least a portion of a trauma strap 430. The pad cover and the housing panel form a channel 414 therebetween and extending between the piping 408 on the top and bottom. Optionally, a securing strap 422 is operatively connected, preferably via the piping 408 and stitching, on opposing sides of the housing 412 (top and bottom), to the base 402. The channel 414 and a channel formed by the securing strap 422 are configured and arranged to receive a leg strap of a safety harness thereby connecting the right combination leg pad and trauma strap 400 to the safety harness. As shown in FIG. 6, the proximal end 431 is similarly connected to the base 402 so that the intermediate portion 438 and distal end 440 can be deployed. In this example, the distal end 440 includes a connector 442 configured and arranged to engage with the connector 342 of the left trauma strap 330.

The combination leg pad and trauma strap can be connected during manufacture of the safety harness when the safety harness is partially assembled or connected after manufacture of the safety harness when the safety harness is fully assembled (retrofit) with leg straps that can be routed through the channels of the combination leg pad and trauma straps.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A combination leg pad and trauma strap, comprising:
a trauma strap including an intermediate portion interconnecting a proximal end and a distal end, the proximal end including a loop forming a first portion and a second portion;
a leg pad including a pad, a pad cover, and a housing panel;
wherein the first portion is positioned proximate the housing panel and the second portion is positioned between the pad cover and the pad, and wherein the pad cover and the housing panel form a channel through the loop between the first and second portions configured and arranged to receive a leg strap of a safety harness thereby connecting the trauma strap to the safety harness when installed on the safety harness.

2. The combination leg pad and trauma strap of claim 1, wherein the loop extends through openings in the pad cover and the housing panel.

3. The combination leg pad and trauma strap of claim 1, further comprising first and second panels releasably connected to each other and connected to the housing panel to form a cavity configured and arranged to receive the intermediate portion and the distal end of the trauma strap in a storage position when not in use.

4. The combination leg pad and trauma strap of claim 3, wherein the first and second panels are disconnectable to deploy the intermediate portion and the distal end of the trauma strap from the cavity in a use position.

5. The combination leg pad and trauma strap of claim 1, wherein the distal end includes at least one of a connector and an adjuster.

6. A combination safety harness and trauma strap, comprising:
a trauma strap including an intermediate portion interconnecting a proximal end and a distal end, the proximal end including a loop forming a first portion and a second portion;
a safety harness including a leg strap;
a leg pad operatively connected to the trauma strap, wherein the leg pad includes a pad, a pad cover, and a housing panel, wherein the first portion is positioned proximate the housing panel and the second portion is positioned between the pad cover and the pad, and wherein the pad cover and the housing panel form a channel through the loop between the first and second portions, wherein the leg strap is routed through the channel thereby connecting the trauma strap to the safety harness.

7. The combination safety harness and trauma strap of claim 6, wherein the trauma strap includes first and second trauma straps and the leg strap includes first and second leg straps, the first and second trauma straps being operatively connected to the first and second leg straps, respectively.

8. The combination leg pad and trauma strap of claim 6, wherein the loop extends through openings in the pad cover and the housing panel.

9. The combination leg pad and trauma strap of claim 6, further comprising first and second panels releasably connected to each other and connected to the housing panel to form a cavity configured and arranged to receive the intermediate portion and the distal end of the trauma strap in a storage position when not in use.

10. The combination leg pad and trauma strap of claim 9, wherein the first and second panels are disconnectable to deploy the intermediate portion and the distal end of the trauma strap from the cavity in a use position.

11. The combination leg pad and trauma strap of claim 6, wherein the distal end includes at least one of a connector and an adjuster.

12. A method of connecting a combination leg pad and trauma strap to a safety harness, comprising:
obtaining a combination leg pad and trauma strap including a leg pad and a trauma strap, the leg pad including a pad, a pad cover, and a housing panel, the trauma strap including an intermediate portion interconnecting a proximal end and a distal end, the proximal end including a loop forming a first portion and a second portion, wherein the first portion is positioned proximate the housing panel and the second portion is positioned between the pad cover and the pad, and wherein the pad cover and the housing panel form a channel through the loop between the first and second portions;
obtaining a safety harness including a leg strap; and
inserting the leg strap through the channel, wherein the leg strap is positioned between the first and second portions of the trauma strap.

13. The method of claim 12, wherein the combination leg pad and trauma strap includes first and second panels releasably connected to each other and connected to the housing panel to form a cavity, further comprising positioning the intermediate portion and the distal end of the trauma strap in a storage position within the cavity when not in use.

14. The method of claim 12, wherein the combination leg pad and trauma strap is connected during manufacture of the safety harness when the safety harness is partially assembled.

15. The method of claim 12, wherein the combination leg pad and trauma strap is connected after manufacture of the safety harness when the safety harness is fully assembled.
